(19) United States
(12) Patent Application Publication
(10) Pub. No.: US 2016/0084193 A1
(43) Pub. Date: Mar. 24, 2016

(54) CYLINDER LINER HAVING FLANGE WITH ANNULAR GROOVE

(71) Applicant: Caterpillar Inc., Peoria, IL (US)

(72) Inventors: Christopher Lee BATTA, West Lafayette, IN (US); Nathan Roger BJERK, Chillicothe, IL (US)

(73) Assignee: CATERPILLAR INC., Peoria, IL (US)

(21) Appl. No.: 14/492,980

(22) Filed: Sep. 22, 2014

(51) Int. Cl. F02F 1/00; F02F 7/00; F02F 11/00; F02F 1/02

(52) U.S. Cl. CPC F02F 1/004; F02F 1/02; F02F 7/00; F02F 11/005

(57) ABSTRACT

A cylinder liner is disclosed for use with an engine. The cylinder liner may have a generally cylindrical body having a top end and a bottom end, and a flange connected to the generally cylindrical body at the top end. The flange may have an external end face, an outer annular surface, and an axial thickness. The cylinder liner may also have a gasket recess formed in the external end face of the flange and having a radial width, and a groove formed in the outer annular surface of the flange at an axial location about midway through the axial thickness of the flange. The groove may have a depth that is about one-third or less of the radial width of the gasket recess.

### TECHNICAL FIELD

The present disclosure relates generally to a cylinder liner and, more particularly, to a cylinder liner having a flange with an annular groove.

### BACKGROUND

An internal combustion engine includes an engine block defining a plurality of cylinder bores, and pistons that reciprocate within the cylinder bores to generate mechanical power. Typically, each cylinder bore includes a liner that is clamped in place by an associated cylinder head and gasket. The liner has a cylindrical body that fits within the cylinder bore, and a radial flange at a top end of the body that supports the cylinder liner on the engine block. A cavity is formed within the cylinder block around the liner, and coolant is directed through the cavity to cool the liner. Clamping of the radial flange to the engine block by the cylinder head and gasket creates a seal that inhibits coolant from leaking out of the cavity. In some applications, a stiffness of the cylinder liner (i.e., a stiffness of the cylindrical body in combination with a stiffness of the radial flange) can result in uneven engagement of the flange with the engine block.

Some cylinder liners are fitted with an anti-polishing ring at an upper end of the cylindrical body near the radial flange. The anti-polishing ring resides within an internal recess of the cylindrical body and has an inner diameter that is slightly smaller than an inner diameter of the liner. In this location, the anti-polishing ring functions to scrape carbon deposits off a top land of the associated piston. While the anti-polishing ring can be effective at removing deposits from the piston, the cylinder liner (particularly the cylindrical body) can also be weakened by the recess. And this weakening can exacerbate the uneven engagement of the flange with the engine block.

One attempt to improve engagement of a cylinder liner with an engine block is disclosed in DE Patent No. 3,530,411 that issued to Nolte on Feb. 26, 1987 (“the '411 patent”). Specifically, the '411 patent discloses a cylinder liner having a collar with a ring groove formed therein. The ring groove is open to the outer side of the collar and has a depth that varies over a circumference of the collar. The ring groove enhances elasticity in the collar, which results in a uniform surface contact pressure on the circumference.

While the cylinder liner of the '411 patent may be an improvement over earlier cylinder liner designs, it may still be problematic. In particular, the ring groove may be too deep in some locations, causing disruption in the force transfer passing through an associated gasket. In addition, the variable depth of the ring groove may increase machining complexity and cost of the liner, while also making precise orientation of the liner during assembly necessary. Finally, the cylinder liner of the '411 patent may lack broad applicability to engines benefiting from or requiring an anti-polishing ring.

The cylinder liner of the present disclosure solves one or more of the problems set forth above and/or other problems in the art.

### SUMMARY

In one aspect, the present disclosure is directed to a cylinder liner. The cylinder liner may include a generally cylindrical body having a top end and a bottom end, and a flange connected to the generally cylindrical body at the top end. The flange may have an external end face, an outer annular surface, and an axial thickness. The cylinder liner may also include a gasket recess formed in the external face of the flange and having a radial width, and a groove formed in the outer annular surface of the flange at an axial location about midway through the axial thickness of the flange. The groove may have a depth that is about one-third or less of the radial width of the gasket recess.

In another aspect, the present disclosure is directed to a cylinder liner assembly. The cylinder liner assembly may include a liner having a generally cylindrical body with a top end and a bottom end, and a flange connected to the generally cylindrical body at the top end. The flange may have an external end face, an outer annular surface, and an axial thickness. The liner may also have a groove formed in the outer annular surface of the flange at an axial location about midway through the axial thickness of the flange. The cylinder liner assembly may further include a gasket recessed within the external end face of the flange and having a mid-located bead and opposing side edges. A depth of the groove in the outer annular surface of the flange may terminate short of the mid-located bead.

In yet another aspect, the present disclosure is directed to an engine. The engine may include a cylinder block at least partially defining a plurality of cylinder bores, and a cylinder liner assembly disposed within each of the plurality of cylinder bores. The cylinder liner assembly may include a liner having a generally cylindrical body with a top end and a bottom end, and a flange connected to the generally cylindrical body at the top end. The flange may have an external end face, an outer annular surface, and an axial thickness. The liner may further have a circular groove formed in the outer annular surface of the flange at an axial location about midway through the axial thickness of the flange. The cylinder liner assembly may also include an anti-polishing sleeve located inside the generally cylindrical body at the top end, and a gasket recessed within the external end face of the flange and having a mid-located bead and opposing side edges. A depth of the groove in the outer annular surface of the flange may terminate short of the mid-located bead, and the depth of the groove in the outer annular surface of the flange may extend under one of the opposing side edges of the gasket. The engine may also include a cylinder head configured to compress the mid-located bead of the gasket and retain the cylinder liner assembly connected to the engine block.

### BRIEF DESCRIPTION OF THE DRAWINGS

FIG. 1 is a cross-sectional illustration of an exemplary disclosed engine;

FIG. 2 is an isometric illustration of an exemplary disclosed cylinder liner assembly that may be used in conjunction with the engine of FIG. 1; and

FIG. 3 is a cross-sectional illustration of a portion of the cylinder liner assembly of FIG. 2.

### DETAILED DESCRIPTION

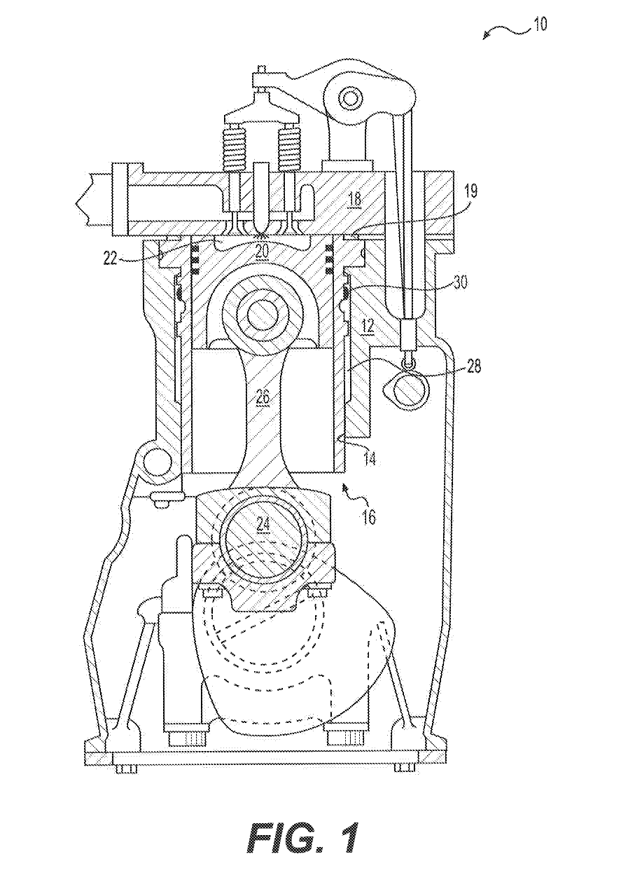

FIG. 1 illustrates a portion of an exemplary internal combustion engine 10. Engine 10 may include an engine block 12 defining one or more cylinder bores 14. A cylinder liner assembly 16 may be disposed within each cylinder bore 14, and a cylinder head 18 may be connected to engine block 12 to close off an end of cylinder bore 14 (e.g., by way of a gasket 19). A piston 20 may be slidably disposed within cylinder liner assembly 16, and piston 20 together with cylinder liner assembly 16 and cylinder head 18 may define a combustion chamber 22. It is contemplated that engine 10 may include any number of combustion chambers 22 and that combustion chambers 22 may be disposed in an “in-line” configuration, in a “V” configuration, in an opposing-piston configuration, or in any other suitable configuration.

Piston 20 may be configured to reciprocate within cylinder liner assembly 16 between a top-dead-center (TDC) position and a bottom-dead-center (BDC) position to facilitate a combustion process with chamber 22. In particular, piston 20 may be pivotally connected to a crankshaft 24 by way of a connecting rod 26, so that a sliding motion of each piston 20 within cylinder liner assembly 16 results in a rotation of crankshaft 24. Similarly, a rotation of crankshaft 24 may result in a sliding motion of piston 20. In a two-stroke engine, piston 20 may move through two full strokes to complete a combustion cycle that includes a power/exhaust/intake stroke (TDC to BDC) and an intake/compression stroke (BDC to TDC). In a four-stroke engine, piston 20 may move through four full strokes to complete a combustion cycle that includes an intake stroke (TDC to BDC), a compression stroke (BDC to TDC), a power stroke (TDC to BDC), and an exhaust stroke (BDC to TDC). Fuel (e.g., diesel fuel, gasoline, gaseous fuel, etc.) may be injected into combustion chamber 22 during the intake strokes of either combustion cycle. The fuel may be mixed with air during the compression strokes and ignited. The heat and pressure resulting from the fuel/air ignition may then be converted to useful mechanical power during the ensuing power strokes. Residual gases may be discharged from combustion chamber 22 during the exhaust strokes.

Heat from the combustion process described above that could damage engine 10, if unaccounted for, may be dissipated from cylinder bore 14 by way of a water jacket 28. Water jacket 28 may be located between an internal wall of cylinder bore 14 and an external wall of cylinder liner assembly 16. For example, water jacket 28 may be formed by a recess within engine block 12 at the internal wall of cylinder bore 14 and/or within the external wall of cylinder liner assembly 16. It is contemplated that water jacket 28 may be formed completely within engine block 12 around cylinder liner assembly 16, formed completely within cylinder liner assembly 16, and/or formed by a hollow sleeve (not shown) that is brazed to either one of engine block 12 or cylinder liner assembly 16, as desired. Water, glycol, or a blended mixture may be directed through water jacket 28 to absorb heat from engine block 12 and cylinder liner assembly 16.

A seal 30 may be disposed around cylinder liner assembly 16 to seal off an upper end of water jacket 28. Seal 30 may be sandwiched between an outer wall of cylinder liner assembly 16 and an inner wall of cylinder bore 14, after assembly, such that coolant within water jacket 28 is inhibited from leaking out of engine block 12 through a top of cylinder bore 14. Seal 30 may be, for example, an o-ring type seal fabricated from a resilient material.

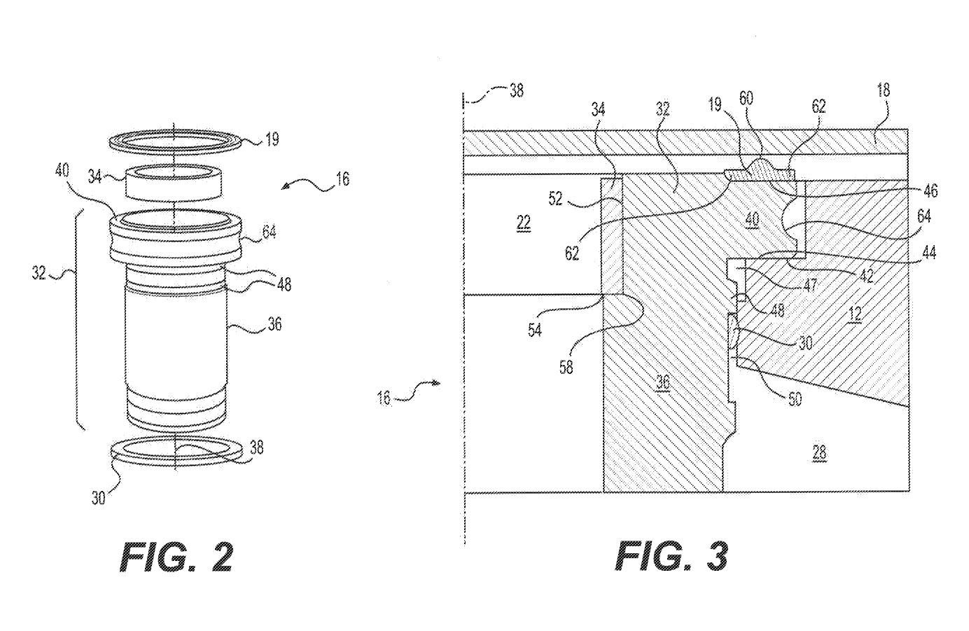

As shown in FIG. 2, cylinder liner assembly 16 may be an assembly of at least four main components, including gasket 19, seal 30, a cylinder liner (“liner”) 32, and an anti-polishing ring or cuff (“ring”) 34. Ring 34 may be fitted into an upper or external end of liner 32 prior to assembly of cylinder liner assembly 16 into cylinder bore 14 of engine block 12. In this position, ring 34 may be configured to receive a top land of piston 20 (referring to FIG. 1). In particular, the top land of piston 20 may slide into ring 34 a distance during each upward stroke that allows ring 34 to scrape away any carbon deposits that have built up on the outer annular surface of piston 20 at a location above any associated piston rings. By scraping away the carbon deposits, the life of engine 10 may be extended.

Gasket 19, as shown in the cross-section of FIG. 3, may include geometry that is compressed during assembly of engine 10. In particular, gasket 19 may include a mid-located bead 60 and adjacent side edges 62 that are formed together as portions of an integral component. In one example, bead 60 and side edges 62 are formed from a material that is heat and corrosion resistant (e.g., stainless steel). Bead 60 may extend axially a distance past a top face of edges 62 and, in this configuration, as cylinder head 18 is bolted to engine block 12, bead 60 may be compressed down to about the same thickness as edges 62 to fill any existing voids or otherwise develop a desired sealing pressure. In the disclosed embodiment, each of bead 60 and side edges 62 have a radial width that is about the same and equal to about ⅓ of a total width of gasket 19.

Seal 30 may be retained at a desired axial location on liner by end stops 48 located at opposing sides of seal 30. Water jacket 28 may fluidly communicate with a lower half of seal 30 via an annular passage 50 formed by a difference of liner and bore diameters at an axial location between end stops 48. This communication may help to cool seal 30.

Liner 32 may have a hollow generally cylindrical body 36 extending along a longitudinal axis 38, and an annular flange 40 protruding radially outward at a top or exposed end of body 36. A lower face 42 of flange 40 may be configured to engage an upper face of 44 of engine block 12, while an external end face 46 of flange 40 may be recessed to receive gasket 19. That is, face 46 may include a gasket recess having a depth about equal to a thickness of side edges 62, and a radial width about equal to a radial width of gasket 19. An annular recess or groove 47 may be formed under flange 40 (i.e., adjacent an inside corner of body 36 and flange 40) to function as an overflow or backup coolant collection cavity. In particular, any coolant that leaks from water jacket 28 past seal 30 may be collected within recess 47, and the engagement of lower face 42 with upper face 44 may inhibit this collected coolant from escaping recess 47.

A groove 64 may be formed within an outer annular surface of flange 40. Groove 64 may be located axially at a general midpoint relative to a thickness of flange 40 (e.g., within about 5% of the midpoint). For example, flange 40 may have a thickness of about 12 mm, and a center of groove 64 may be located at about 6 mm from lower face 42. Groove 64 may have a radial depth that is about one-third or less of a width of the gasket recess formed in face 46 (e.g., about ¼ of the width of the gasket recess) such that the depth of groove 64 terminates under side edge 62 just short of bead 60. In other words, groove 64 may not extend under bead 60, in order to allow forces passing through bead 60 to be transferred downward through flange 40 without significant disruption by groove 64. In this configuration, the depth of groove 64 is about 2-2.5 times a radial width of ring 34. Groove 64 may have a circular cross-section, with a radius about equal to one-fourth of a thickness of flange 40 (e.g., about equal to 3 mm). In the disclosed embodiment, the radius of groove 64 may be about 1.5-2 times the depth. Groove 64 may have a substantially constant depth (e.g., within about 5%) around a circumference of flange 40.

An internal annular recess 52 may be formed at the top end of body 36 and configured to receive ring 34. Ring 34 may be fitted into recess 52, and have an internal diameter less than an internal diameter of body 36. With this configuration, a step 54 may be created that interacts with piston 20 to scrape away the carbon buildup described above. Ring 34 may extend axially from the exposed end of body 36 downward past recess 47 to about the same axial location as the upper end stop 48.

### INDUSTRIAL APPLICABILITY

The disclosed cylinder liner may be used in any application where it is desired to increase the reliability and operating life of the associated engine. The disclosed cylinder liner may increase reliability and operating life by enhancing sealing and improving contact pressure consistency at an interface between the cylinder liner and an associated engine block. This enhanced sealing may be provided by increasing flexibility in the flange of the cylinder liner by way of an annular groove.

The geometry (e.g., axial location, depth, radius, and shape) of groove 64 may be selected to provide a desired amount of flexibility within flange 40, while also reducing machining time and cost of cylinder liner 32. For example, the location of groove 64 being about midway through a thickness of flange 40 may allow for a substantially equal distribution of forces passing through bead 60 to lower face 42 and a desired amount of flexibility. A location closer to face 46 may not provide adequate elasticity within flange 40, while a location closer to lower face 42 may not allow for adequate force distribution. In addition, a location closer to one face or the other may reduce a strength of flange 40. The depth of groove 64 may be selected to allow for the desired amount of elasticity without creating stress risers within flange 40. In particular, a deeper groove (e.g., a groove having a depth that passes under bead 60) may disrupt the transfer of axial force and result in stress risers at groove 64 and/or at internal edges of flange 40. A shallower groove (e.g., a groove having a depth that does not pass under side edge 62) may not provide enough elasticity within flange 40. The radius, shape, and circumferential consistency of groove 64 may be selected to reduce machining time and cost, while also inhibiting the formation of stress risers. In particular, by having only curved surfaces, machining may be simplified and transition points (i.e., points located at transitions between straight and curved surfaces) may be eliminated. In addition, the consistent depth of groove 64 around the circumference of flange 40 may allow for cylinder liner 32 to be assembled in any orientation, which can simplify construction of engine 10.

It will be apparent to those skilled in the art that various modifications and variations can be made to the disclosed cylinder liner. Other embodiments will be apparent to those skilled in the art from consideration of the specification and practice of the disclosed cylinder liner. It is intended that the specification and examples be considered as exemplary only, with a true scope being indicated by the following claims and their equivalents.

What is claimed is:

1. A cylinder liner, comprising:
a generally cylindrical body having a top end and a bottom end;
a flange connected to the generally cylindrical body at the top end, and having an external end face, an outer annular surface, and an axial thickness;
a gasket recess formed in the external end face of the flange and having a radial width; and
a groove formed in the outer annular surface of the flange at an axial location about midway through the axial thickness of the flange and having a depth that is about one-third or less of the radial width of the gasket recess.

2. The cylinder liner of claim 1, wherein the depth of the groove is about one-fourth of the radial width of the gasket recess.

3. The cylinder liner of claim 1, wherein the groove has a circular cross-section.

4. The cylinder liner of claim 3, wherein a radius of the circular cross-section is about equal to one-fourth of the axial thickness of the flange.

5. The cylinder liner of claim 3, wherein a radius of the circular cross-section is about 1.5-2 times the depth of the groove.

6. The cylinder liner of claim 1, wherein the depth of the groove is substantially constant around a circumference of the flange.

7. The cylinder liner of claim 1, further including an anti-polishing sleeve recess formed inside the generally cylindrical body at the top end.

8. The cylinder liner of claim 7, wherein the depth of the groove is about 2-2.5 times a radial width of the anti-polishing sleeve recess.

9. The cylinder liner of claim 1, further including a cooling chamber recess formed within an external surface of the generally cylindrical body and adjacent an internal face of the flange.

10. A cylinder liner assembly, comprising:
a liner having:
a generally cylindrical body having a top end and a bottom end;
a flange connected to the generally cylindrical body at the top end, and having an external end face, an outer annular surface, and an axial thickness; and
a groove formed in the outer annular surface of the flange at an axial location about midway through the axial thickness of the flange; and
a gasket recessed within the external end face of the flange and having a mid-located bead and adjacent side edges,
wherein a depth of the groove in the outer annular surface of the flange terminates short of the mid-located bead.

11. The cylinder liner assembly of claim 10, wherein the depth of the groove in the outer annular surface of the flange extends under one of the opposing side edges of the gasket.

12. The cylinder liner assembly of claim 10, wherein:
the groove has a circular cross-section; and
a radius of the circular cross-section is about equal to one-fourth of the axial thickness of the flange.

13. The cylinder liner assembly of claim 12, wherein a radius of the circular cross-section is about 1.5-2 times the depth of the groove.

14. The cylinder liner assembly of claim 10, wherein the depth of the groove is substantially constant around a circumference of the flange.

15. The cylinder liner assembly of claim 10, further including an anti-polishing sleeve located inside the generally cylindrical body at the top end.

16. The cylinder liner assembly of claim 15, wherein the depth of the groove is about 2-2.5 times an radial width of the anti-polishing sleeve.

17. The cylinder liner assembly of claim 10, wherein the liner further includes a cooling chamber recess formed within an external surface of the generally cylindrical body and adjacent an internal face of the flange.

18. An engine, comprising:
a cylinder block at least partially defining a plurality of cylinder bores;
a cylinder liner assembly disposed within each of the plurality of cylinder bores and including:
a liner having:
a generally cylindrical body having a top end and a bottom end;
a flange connected to the generally cylindrical body at the top end, and having an external end face, an outer annular surface, and an axial thickness; and
a circular groove formed in the outer annular surface of the flange at an axial location about midway through the axial thickness of the flange;
an anti-polishing sleeve located inside the generally cylindrical body at the top end; and
a gasket recessed within the external end face of the flange and having a mid-located bead and opposing side edges, wherein:
a depth of the circular groove in the outer annular surface of the flange terminates short of the mid-located bead; and
the depth of the circular groove in the outer annular surface of the flange extends under one of the opposing side edges of the gasket; and
a cylinder head configured to compress the mid-located bead of the gasket and retain the cylinder liner assembly connected to the cylinder block.

19. The engine of claim 18, wherein:
a radius of the circular groove is about equal to one-fourth of the axial thickness of the flange; and
a radius of the circular groove is about 1.5-2 times the depth of the circular groove.

20. The engine of claim 18, wherein:
the depth of the circular groove is substantially constant around a circumference of the flange; and
the depth of the circular groove is about 2-2.5 times a radial width of the anti-polishing sleeve.
